(19) United States
(12) Patent Application Publication
(10) Pub. No.: US 2024/0345013 A1
(43) Pub. Date: Oct. 17, 2024

(54) CATALYTIC COMBUSTION TYPE HYDROGEN SENSOR AND MANUFACTURING METHOD THEREFOR

(71) Applicant: ZHEJIANG UNIVERSITY OF TECHNOLOGY, Zhejiang (CN)

(72) Inventors: Jun HU, Zhejiang (CN); Bo XIE, Zhejiang (CN); Bosheng DING, Zhejiang (CN); Wenjing YAN, Zhejiang (CN); Yingzhu LI, Zhejiang (CN); Shengjie XIA, Zhejiang (CN)

(73) Assignee: ZHEJIANG UNIVERSITY OF TECHNOLOGY, Zhejiang (CN)

(21) Appl. No.: 18/752,708

(22) Filed: Jun. 24, 2024

Related U.S. Application Data
(63) Continuation-in-part of application No. PCT/CN2022/079734, filed on Mar. 8, 2022.

(30) Foreign Application Priority Data
Dec. 27, 2021 (CN) 202111621009.0

(51) Int. Cl. G01N 27/16

(52) U.S. Cl. CPC G01N 27/16

(57) ABSTRACT

Disclosed in the present disclosure are a catalytic combustion type hydrogen sensor and a manufacturing method therefor. The catalytic combustion type hydrogen sensor includes a catalytic combustion element and a compensation element, where both the catalytic combustion element and the compensation element are planar film structures taking mica sheets as substrates, and platinum resistors and aluminum oxide film carriers are sequentially adhered on surfaces of the mica sheets. A layer of palladium nanoparticles are further adhered to a surface of the aluminum oxide film carrier of the catalytic combustion element as a catalyst. According to the present disclosure, the ultra-thin mica sheet is used for replacing a silicon-based material to manufacture the film type catalytic combustion type hydrogen sensor, such that a complicated and high-cost micro-electromechanical system (MEMS) technology is avoided, and the flexible characteristic of the ultra-thin mica sheet endows the sensor with extremely high robustness.

### CROSS-REFERENCE TO RELATED APPLICATION

This application is a continuation-in-part of international application of PCT application serial no. PCT/CN2022/079734 filed on Mar. 8, 2022, which claims the priority benefit of China application no. 202111621009.0, filed on Dec. 27, 2021. The entirety of each of the above mentioned patent applications is hereby incorporated by reference herein and made a part of this specification.

### BACKGROUND

### Technical Field

The present disclosure relates to the technical field of gas sensing, and in particular to a catalytic combustion type hydrogen sensor and a manufacturing method therefor.

### Description of Related Art

As a form of energy, hydrogen has high combustion efficiency, and the product of water has the advantages of no pollution, etc., so hydrogen has the potential to replace traditional fossil fuels. However, as a flammable and explosive gas, the hydrogen has potential safety hazards in the production, storage and use processes. Moreover, the hydrogen is a colorless, odorless and tasteless gas, so when the hydrogen leaks, it cannot be detected by a human sensory system. Therefore, development of a hydrogen sensing technology with practical application value is an important security guarantee for realizing large-scale application of hydrogen energy.

Hydrogen fuel cell vehicles are the largest application scenario of hydrogen sensors, and the stability of product performance is required to be very high in the vehicle-mounted field. At present, a catalytic combustion-type hydrogen sensor is the most suitable vehicle-mounted hydrogen sensing technology because the hydrogen sensor has a compensation function and can eliminate baseline drift of the sensor to the greatest extent. However, the traditional catalytic combustion type hydrogen sensor employs a filament structure and works under the complex working condition of vehicle-mounted vibration for a long time, such that a filament is likely to break and the device fails, which limits the application of the catalytic combustion type hydrogen sensor in the vehicle-mounted field. In order to solve this problem, the catalytic combustion sensor with a micro-electromechanical system (MEMS) planar structure emerges at the right moment. For the MEMS type catalytic combustion type hydrogen sensor, a catalytic combustion sensitive element is constructed on the surface of a very thin silicon oxide or nitride layer (called a “floating bridge” structure) using a semiconductor micro-nano machining technology (see patents KR20090011622A, KR20100026810A, and JPH116811A). The miniaturized planar device structure improves the sensing performance in a certain range, and also eliminates the fragile characteristic caused by a filament structure. However, the MEMS-type catalytic combustion gas sensor usually employs the “floating bridge” structure, in order to reduce the heat capacity and obtain better sensing performance, it is often necessary to machine the “bridge body” very thin, typically on the order of microns. The ultra-thin structural characteristic and the brittleness of the silicon-based material itself lead to low robustness and fabrication consistency of the device (referring to DOI: 10.1016/j.cjac.2021.09.002). In addition, the manufacturing process of this MEMS device is complicated (referring to patent KR20100026810A), and the cost is relatively high. It is still a challenging task to realize the catalytic combustion hydrogen sensing function with a planar structure by using a simple process at a low cost.

Therefore, the “floating bridge” structure of the existing MEMS-type catalytic combustion gas sensor leads to many restrictions in the applications. One of the ways to solve this problem is to replace the “floating bridge” with a simpler device structure. The key to this idea is to find a new substrate material instead of a silicon-based material to avoid the complex MEMS process. According to the working principle of the catalytic combustion type gas sensor and the goal of improving the robustness of the device, the substrate material should satisfy the four conditions: (1) good mechanical flexibility, (2) high-temperature resistance, (3) insulation, and (4) a low specific heat capacity. Polymers have been used as substrate materials in some studies to obtain good flexibility (referring to DOI: 10.1021/acsami.8b15445), but the polymers cannot withstand high temperatures and do not satisfy the conditions (2), so the polymers cannot be used as substrates of the catalytic combustion type hydrogen sensors. All metal materials cannot satisfy the condition (3), so the choice of substrate materials is mainly concentrated in inorganic ceramic materials. However, most inorganic ceramic materials do not possess the characteristic (1), with the exception of ultra-thin mica sheets, which is discovered by the applicant during the research, and the ultra-thin mica flakes possess all four of the above characteristics. Therefore, the present application proposes to select an ultra-thin mica sheet as a substrate, and employ two-step physical vapor deposition to construct a catalytic combustion type hydrogen sensor with a planar structure, so as to overcome the application limitation of the existing MEMS type catalytic combustion type hydrogen sensor. Furthermore, mica has a specific heat capacity of 836 J·kg⁻¹·K⁻¹, which is lower than silica's specific heat capacity of 964 J·kg⁻¹·K⁻¹. The lower specific heat capacity also leads to better device performance (higher catalytic combustion temperatures and faster temperature changes under the same conditions).

Although in a resistor-type hydrogen sensor mentioned in the existing patent application, mica is mentioned to serve as a substrate to construct a hydrogen sensor (CN109991284A), it cannot be considered that there is a simple substitution relationship between the resistor-type hydrogen sensor and the catalytic combustion type hydrogen sensor. Because the resistor type hydrogen sensors usually only require insulating substrates to satisfy the application conditions, and as mentioned above, the catalytic combustion-type hydrogen sensors have stricter requirements for the substrate materials, and it is necessary to combine the application conditions of the catalytic combustion-type gas sensors and the technical bottlenecks of the existing MEMS devices to examine the physical and chemical properties of the selected substrate materials.

### SUMMARY

An objective of the present disclosure is to provide a catalytic combustion-type hydrogen sensor and a manufacturing method therefore, so as to overcome the defects of the prior art, and realize the purpose of manufacturing a catalytic combustion-type hydrogen sensor with a planar structure at a low cost. In the catalytic combustion type hydrogen sensor, a platinum resistor employs a planar structure, such that the fragile characteristic of a traditional filament structure is avoided. Moreover, a mica sheet serves as a substrate of the planar structure, and the platinum resistor is manufactured by utilizing magnetron sputtering in combination with a mask, such that a complex manufacturing technology and a high-cost manufacturing process of a traditional micro-electromechanical system (MEMS) type catalytic combustion type device are avoided.

The catalytic combustion type hydrogen sensor includes a catalytic combustion element and a compensation element, where both the catalytic combustion element and the compensation element are planar film structures taking mica sheets as substrates, and a concentration of external hydrogen is reflected by measuring the resistance change of the catalytic combustion element. The catalytic combustion element includes a planar platinum resistor, an aluminum oxide film carrier layer, and palladium nanoparticle catalyst. The compensation element is provided with a platinum resistor and an aluminum oxide film carrier layer like the catalytic combustion element, and has no palladium nanoparticle catalyst, which is the difference. The catalytic combustion element is configured to detect a concentration of hydrogen, and the compensation element is configured to form a bridge measuring circuit and realize a temperature compensation function.

Furthermore, the catalytic combustion element and the compensation element may be located on the same mica sheet substrate, or located on respective mica sheet substrates independently.

Preferably, the mica sheet with thickness of 10-100 μm was used as a device substrate. As an important supporting structure, the mica sheet carries the planar structure of the platinum resistor of the whole sensor, which can effectively avoid the fracture problem of a traditional filament structure under a vibration condition.

Preferably, the platinum resistor is manufactured by a magnetron sputtering coating method, and the shape structure of the platinum resistor is realized by using a corresponding mask, such that the semiconductor technological process such as photolithography with a complicated manufacturing technology and a high cost are avoided, and the thickness of the platinum resistor is controlled to be 1-10 μm. A Ti or Cr film with a thickness of 1-5 nm is deposited on the mica substrate by means of magnetron sputtering as an adhesive layer before platinum resistor plating.

Preferably, the aluminum oxide film carrier layer is realized by a radio-frequency magnetron sputtering coating method, and coating in a selected region is also realized by using a mask. The coating region covers the surface of the entire region where the platinum resistor is distributed, and the thickness of the aluminum oxide film is controlled within the range of 5-50 μm.

Preferably, the palladium nanoparticle catalyst is prepared by using a cluster beam deposition technology, the particle size of palladium nanoparticles is controlled to be 5-20 nm, and palladium nanoparticles adhere to and cover the surface of the entire region where the aluminum oxide film is distributed.

A manufacturing method for a catalytic combustion-type hydrogen sensor is provided, and the manufacturing process of the platinum resistor includes the following steps:
(1) attaching a mask with a specific structure to the surface of mica, and plating titanium or chromium on the surface of the mica sheet as an adhesive layer by a magnetron sputtering coating method; and
(2) after coating the adhesive layer, plating a platinum layer by the magnetron sputtering coating method to obtain the structure of a platinum resistor.

Preferably, the manufacturing process of the aluminum oxide film carrier layer includes the following steps: plating an aluminum oxide layer at the platinum resistor position using a mask by a radio-frequency magnetron sputtering coating method, where the coating region of the aluminum oxide layer covers the surface of the entire region where the platinum resistor is distributed.

Preferably, a preparation process of the palladium nanoparticle catalyst includes the following steps: depositing palladium nanoparticles on the surface of the aluminum oxide film carrier layer by a magnetron plasma gas aggregation method in combination with a cluster beam technology.

The innovation point of the present disclosure lies in that the high-temperature resistant characteristic of the mica sheet is utilized to replace a silicon substrate in the existing MEMS device, magnetron sputtering and mask are utilized to replace semiconductor technologies such as photolithography, and the planar platinum resistor structure is manufactured on the substrate, such that the advantages of simple technology and a low cost are achieved. According to the present disclosure, the catalytic combustion type hydrogen sensing structure having a planar structure is constructed on the mica substrate, such that the structure of a traditional filament-type catalytic combustion device is avoided, the filament fracture problem caused by vibration can be effectively avoided, and a catalytic combustion type hydrogen sensor with high performance and a stable structure can be provided for a vehicle-mounted application scenario.

When the catalytic combustion type hydrogen sensor of the present application is used for detecting the concentration of hydrogen, the catalytic combustion element is heated to an initial temperature (about 560° C.) of hydrogen oxidation, and when the hydrogen is in contact with the catalyst, flameless combustion of the hydrogen is achieved with the assistance of the catalyst to release heat to increase the resistance value of the platinum resistor, thereby detecting the concentration of the hydrogen. In the catalytic combustion type hydrogen sensor provided by the present application, the basic structure and physical properties of the compensation element are the same as those of the catalytic combustion element, only catalyst palladium nanoparticles are omitted, and hydrogen does not generate a combustion reaction on the surface. The compensation element is mainly configured to form a bridge measuring circuit and realize a temperature compensation function.

Compared with the prior art, the present disclosure achieves the beneficial effects as follows.

1) According to the present disclosure, the mica sheets are employed to replace silicon substrates, the platinum resistor structure, the aluminum oxide film carrier layer, and the palladium nanoparticle catalyst are manufactured on the substrate by using the multi-target magnetron sputtering in combination with the mask, and finally, the catalytic combustion type hydrogen sensor is obtained. The planar structure with mica support has more stable mechanical properties than the traditional filament structure, can work in a vibration environment, and avoids the semiconductor technology with a complex process and a high cost such as photolithography, and therefore, a new catalytic combustion type hydrogen sensor is provided.

2) The catalytic combustion type hydrogen sensor disclosed in the present disclosure combines the low-cost advantage of the filament catalytic combustion device with the structural stability of the MEMS type catalytic combustion type gas sensor.

3) The catalytic combustion type hydrogen sensor based on the ultra-thin mica sheet provided by the present disclosure simplifies the manufacturing process technology, reduces the cost, and improves the robustness.

### BRIEF DESCRIPTION OF THE DRAWINGS

FIG. 1 is a schematic structural diagram of a catalytic combustion-type hydrogen sensor provided by the present disclosure.

FIG. 2 is a schematic diagram of apparatuses for manufacturing a platinum resistor and an aluminum oxide film of the present disclosure.

FIG. 3 is an optical image under bending of a catalytic combustion type hydrogen sensor with a mica sheet as a substrate manufactured by the present disclosure.

FIG. 4 is a schematic diagram of apparatuses for manufacturing a platinum resistor and an aluminum oxide film by using multi-target magnetron sputtering in Example 1 of the present disclosure.

FIG. 5 is a graph showing hydrogen sensing performance testing results of a catalytic combustion type hydrogen sensor manufactured in Example 1 of the present disclosure before and after 100 times of bending, and the illustrations show fixtures used for bending cycles and samples in different bending states.

FIG. 6 is a graph showing the performance testing results of five groups of catalytic combustion-type hydrogen sensors with different palladium loading manufactured in Example 2 of the present disclosure.

FIG. 7 shows transmission electron microscopy characterization results and the equivalent thickness of palladium catalytic layers of five groups of samples with different palladium loading manufactured in Example 2 of the present disclosure.

In the figures: 1—mica sheet, 2—platinum resistor, 3—aluminum oxide film, 4—palladium nanoparticle, 5—mask, 6—magnetron sputtering apparatus, 7—magnetron sputtering titanium target, 8—magnetron sputtering platinum target, and 9—magnetron sputtering aluminum oxide target.

### DESCRIPTION OF THE EMBODIMENTS

The present disclosure is further described below in conjunction with particular examples, but the protection scope of the present disclosure is not limited herein.

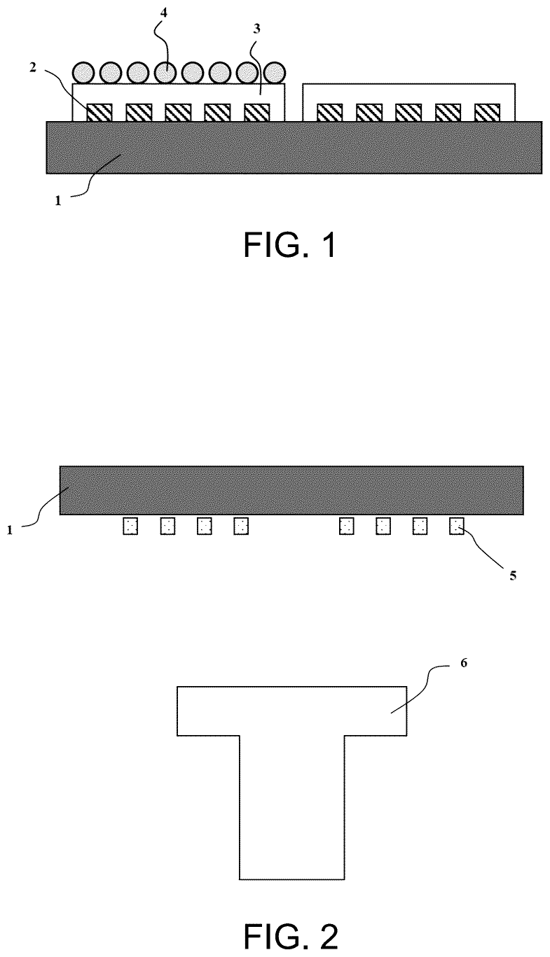

As shown in FIG. 1, a catalytic combustion type hydrogen sensor of the present disclosure includes two elements having the structures which are essentially same, namely a catalytic combustion element and a compensation element. Both the two elements take mica sheets 1 as insulating substrates. A platinum resistor 2 having a planar structure serves as a measuring unit, an aluminum oxide film 3 covers the platinum resistor 2 as a carrier layer, palladium nanoparticles 4 are attached to the surface of the aluminum oxide film 3, and finally a catalytic combustion element is formed. The compensation element has a structure that is essentially the same as the catalytic combustion element, and is only provided with a mica sheet 1, a platinum resistor 2, and an aluminum oxide film 3, and no palladium nanoparticles 4 are arranged on the aluminum oxide film 3. The catalytic combustion element and the compensation element may be located on the same mica sheet substrate, or located on respective mica sheet substrates independently. In this example, the same mica sheet substrate is employed.

The platinum resistor 2 and the aluminum oxide film 3 in the present disclosure are both manufactured by a magnetron sputtering method, and the pattern structure is realized by means of mask occlusion, as shown in FIG. 2. First, a mica sheet 1 with a size of 60×60 mm and a thickness of 25 microns is selected as an insulating substrate, a mask 5 with a desired pattern is attached to the surface of the mica sheet, and a platinum target or an aluminum oxide target is sputtered by using a magnetron sputtering apparatus 6. Titanium or chromium with a thickness of about 5 nm may be plated as an adhesive layer before plating of the platinum resistor 2 to enhance the bonding force between metal platinum and the mica sheet substrate. In the above metal coating process, argon gas is introduced into a sputtering chamber to about 1 Pa, sputtering is performed by using a direct current sputtering power supply, the power is about 30 W, and the film thickness of the platinum resistor is controlled to be 1-10 μm by controlling the coating time. Sputtering coating is performed on the aluminum oxide film 3 by using a radio-frequency sputtering power supply, the power is 150-200 W, and the film thickness is controlled to be 5-50 μm.

Palladium nanoparticles are manufactured by a cluster beam deposition method. Sputtering gas is argon, buffer gas is argon, and the sputtering power is 20-30 W. The palladium nanoparticles are deposited on the surface of the aluminum oxide film of the catalytic combustion element by using the appropriate mask for occlusion.

The catalytic combustion type hydrogen sensor employs the planar structure having the mica sheet substrate, and can be applied to application scenarios such as vehicles under vibration conditions for a long time. Furthermore, the manufacturing technology is simple, and complex manufacturing processes and a high cost caused by the micro-electromechanical system (MEMS) technology are avoided.

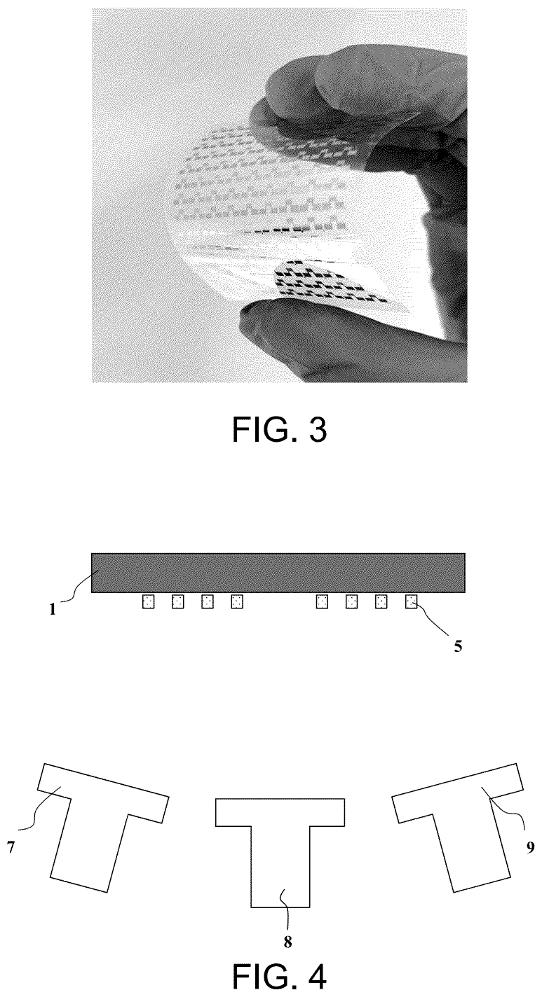

An optical image of the catalytic combustion type hydrogen sensor manufactured in batches by using a mica sheet 1 with a thickness of 20 microns as an insulating substrate in an example of the present disclosure in a bending state is shown in FIG. 3. FIG. 3 shows the catalytic combustion-type hydrogen sensor maintains good flexibility in the bending state.

Example 1: A catalytic combustion-type hydrogen sensor was manufactured, and sensing response before and after repeated mechanical deformation was compared, which included the specific steps as follows:

(1) A mica sheet with a thickness of 25 μm was selected as a substrate material, and was immersed in a 1:1 hydrogen peroxide and isopropanol mixed solution for ultrasonic cleaning for later use.

(2) A platinum resistor was manufactured by using a multi-target magnetron sputtering system as shown in FIG. 4. A total of titanium, platinum, and aluminum oxide targets were placed on three magnetron sputtering target sources respectively, Ar gas was introduced by means of a mass flowmeter, and gas pressure was maintained at 0.5 Pa. A direct current sputtering power supply was used for driving the sputtering of the titanium target at the power of 50 W, and patterns were formed by means of a mask 5. The film thickness was monitored by a film thickness meter, and a titanium film with a thickness of 5 nm was deposited. Platinum was then deposited in the same manner to form a platinum resistor with a thickness of 1 μm. Finally, the sputtering of the aluminum oxide target was driven by a radio-frequency sputtering power source with the power of 100 W, and the surface of the platinum resistor was covered by an aluminum oxide film with a thickness of 25 μm.

(3) Palladium nanoparticles were deposited on the mica sheet by using a cluster beam deposition technology, where the platinum resistor was manufactured, and aluminum oxide covered the surface of the platinum resistor. Specifically, palladium nanoparticles were generated by a magnetron plasma gas aggregation method, and nanoparticles were generated at the direct current sputtering power of 25 W in an argon atmosphere of 100 Pa. Nanoparticle beams were formed in differential vacuum, and deposition was performed at a rate of 0.5 Å/s for 3000 s.

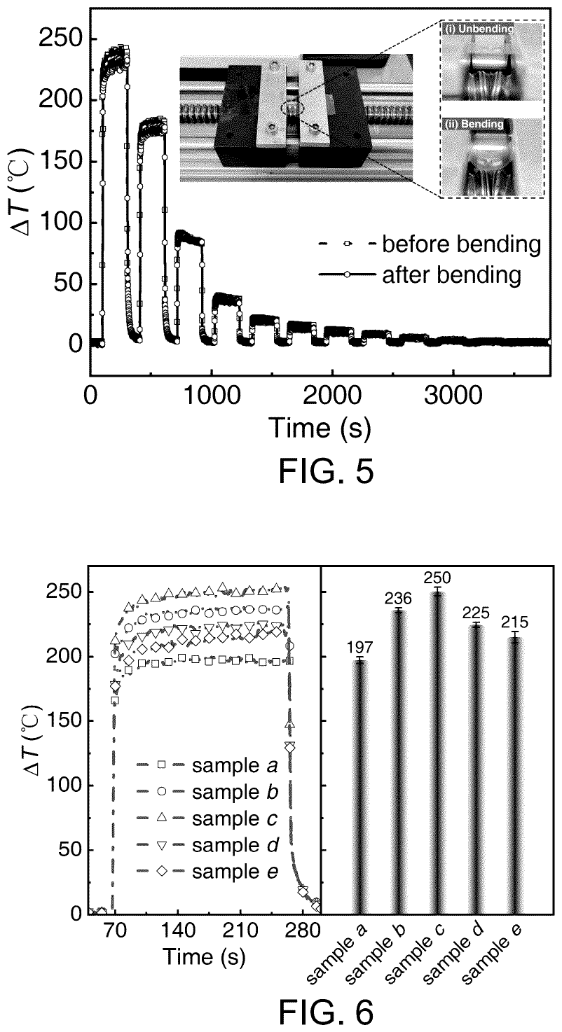

(4) The device obtained by the above method was bent 100 times repeatedly, and the radius of curvature of the bending was about 10 mm. Hydrogen sensing performance testing was conducted before and after bending. Comparison results of hydrogen sensing performance and fixtures used for repeated bending are shown in FIG. 5. During the bending process, both ends of the mica sheet were clamped on a pair of sliding blocks, the sliding blocks were driven by a stepping motor, and the motor drove the sliding blocks to reciprocate, such that the mica sheet was bent repeatedly. In the hydrogen sensing test, the sensor was placed in a closed test cavity, dry air was introduced at 5000 sccm as background gas by a flow meter, and another flow meter was used for controlling the flow rate of hydrogen to achieve the purpose of mixing different hydrogen flows (see DOI: 10.1021/acssensors.4c00269 for details). A digital source meter was used to collect the change in resistance when a voltage of 1.5 V was applied to the sensor sample. The temperature T could be calculated by using the formula R(T)=R(T′)[1+α(T−T′)]. In the formula, R(T) and R(T′) represent resistance values of the platinum resistor at the temperatures of T and T′ respectively. T′ is taken as 25° C. (R(T′) is directly measured). Tis the real-time temperature of the platinum resistor. α is the resistance temperature coefficient of the platinum resistor, which is measured as 3740 ppm/° C. A response curve can be plotted with the temperature change ΔT as the response value (FIG. 5).

FIG. 5 shows that after repeated bending, the catalytic combustion type hydrogen sensor based on the mica substrate has no obvious attenuation in response performance for detecting hydrogen, and still maintains almost the same hydrogen sensing response curve as that without bending cycle.

Example 2: Sensors having different palladium loading were manufactured, and hydrogen sensing performance was compared.

(1) A platinum resistor structure was manufactured on a mica sheet in the same manner as in steps (1) and (2) of Example 1.

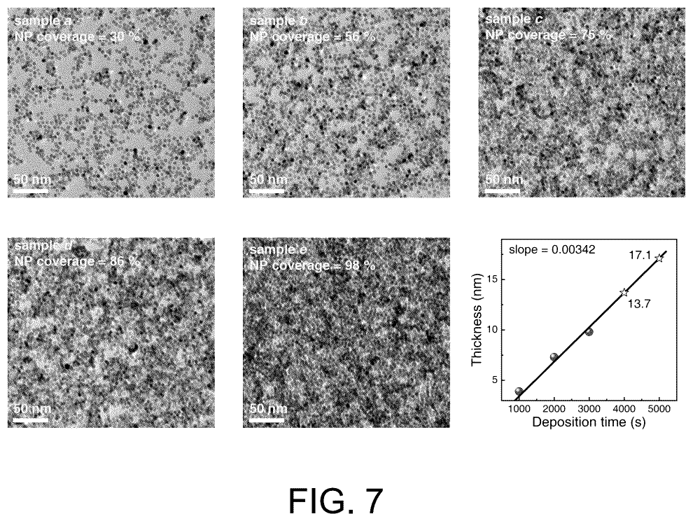

(2) A palladium catalyst was deposited on the catalytic combustion element, and the method for preparation was substantially the same as step (3) of Example 1. Here, five samples were manufactured, and the deposition time of the palladium nanoparticles was 1000, 2000, 3000, 4000, and 5000 s respectively. The obtained samples were recorded as sample a-e. During the deposition of the palladium nanoparticles, a copper mesh (TEM copper mesh) for transmission electron microscopy (TEM) characterization was placed beside the mica substrate, which was called TEM copper mesh for short, such that the palladium nanoparticles were deposited on the TEM copper mesh simultaneously for TEM characterization. The amount of palladium deposition was quantified by means of an equivalent thickness: the average size of the palladium nanoparticles was about 13 nm according to TEM characterization results, and the coverage of nanoparticles was calculated by using ImageJ software. The deposition of the average size and coverage served as the equivalent thickness. It is worth noting that samples d and e exceed one monolayer, and the equivalent thickness is obtained by means of linear extrapolation from the results of samples a-c. The equivalent thicknesses of the palladium catalyst layers for samples a-e are 3.9, 7.3, 9.8, 13.7, and 17.1 nm respectively, as shown in FIG. 7.

(3) Hydrogen response characteristics testing of samples a-e manufactured as described above was performed. In the hydrogen sensing test, the five sensors were placed in a closed test cavity, dry air was introduced as background gas by means of a flowmeter at 5000 sccm, and another flowmeter was used for controlling the flow rate of hydrogen to 200 sccm, such that the samples were exposed to a hydrogen environment with a concentration of about 4%. A digital source meter was used to collect the change in resistance when a voltage of 1.5 V was applied to the sensor sample. The temperature T could be calculated by using the formula R(T)=R(T′)[1+α(T−T′)]. In the formula, R(T) and R(T′) represent resistance values of the platinum resistor at the temperatures of T and T′ respectively. T′ is taken as 25° C. (R(T′) is directly measured). Tis the real-time temperature of the platinum resistor. α is the resistance temperature coefficient of the platinum resistor, which is measured as 3740 ppm/° C. A response curve and histogram of a response value can be plotted with the temperature change ΔT as the response value (FIG. 6).

FIG. 6 shows that with the increase of palladium nanoparticle deposition amount, the response value of hydrogen detection is increased first and then is decreased, and the order of palladium nanoparticle deposition amount of sample c is at the middle position, but it has the maximum response value. The results show that the monolayer structure covered with the nanoparticles as much as possible is more conducive to the play of performance of the device, which means that the optimal device performance can be obtained without using a large amount of noble metal palladium catalysts, and the cost of the device can be further reduced by controllable manufacturing means.

What is claimed is:

1. A catalytic combustion type hydrogen sensor, comprising a catalytic combustion element and a compensation element, wherein both the catalytic combustion element and the compensation element are planar film structures taking mica sheets as substrates, and platinum resistors and aluminum oxide film carriers sequentially adhere on surfaces of the mica sheets; and a layer of palladium nanoparticles further adhere to a surface of the aluminum oxide film carrier of the catalytic combustion element as a catalyst, the catalytic combustion element is configured to detect a concentration of hydrogen, and the compensation element is configured to form a bridge measuring circuit and realize a temperature compensation function.

2. The catalytic combustion type hydrogen sensor according to claim 1, wherein the catalytic combustion element and the compensation element employ the same mica sheet substrate, or employ different mica sheet substrates independently.

3. The catalytic combustion type hydrogen sensor according to claim 1, wherein the mica sheet substrate has a thickness of 10-100 μm, the platinum resistor has a thickness of 1-10 μm, and the aluminum oxide film carrier has a thickness of 5-50 μm.

4. The catalytic combustion type hydrogen sensor according to claim 1, wherein the palladium nanoparticles have a particle size of 5-20 nm, and in the structure of the catalytic combustion element, the palladium nanoparticles adhere to and cover the surface of the region where the aluminum oxide film carrier is distributed.

5. A manufacturing method for the catalytic combustion type hydrogen sensor according to claim 1, comprising the following steps:
step 1) attaching a mask to a surface of mica, plating titanium or chromium on the surface of the mica sheet as an adhesive layer by a magnetron sputtering coating method, and then, further plating a platinum layer by the magnetron sputtering coating method to obtain the structure of the platinum resistor;
step 2) plating an aluminum oxide film carrier layer on the platinum resistor, wherein the aluminum oxide film carrier layer is formed by a radio-frequency magnetron sputtering coating method, coating in a selected region is also realized by using a mask, and the coating region covers the surface of entire region where the platinum resistor is distributed; and
step 3) manufacturing the catalytic combustion element and the compensation element according to the method in the above steps 1) and 2), wherein a palladium nanoparticle catalyst is prepared on the aluminum oxide film carrier layer by using a cluster beam deposition technology continuously when the catalytic combustion element is manufactured, and the palladium nanoparticles adhere to and cover the surface of entire region where the aluminum oxide film is distributed.
